(19) United States
(12) Patent Application Publication
(10) Pub. No.: US 2008/0268238 A1
(43) Pub. Date: Oct. 30, 2008

(54) Sticker for Sticking Onto an Object

(75) Inventors: David Tuffe, Hamburg (DE); Annouschka Blazejewski, Hamburg (DE); Stefan Stadler, Hamburg (DE); Joern Leiber, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA SCRIBOS GMBH, Heidelberg (DE)

(21) Appl. No.: 12/088,048

(22) PCT Filed: Nov. 6, 2006
(86) PCT No.: PCT/EP2006/068120

§ 371 Date: Apr. 28, 2008

(30) Foreign Application Priority Data
Nov. 9, 2005 (DE) 10 2005 053 508.9

(51) Int. Cl. C09J 7/02

(52) U.S. Cl. 428/337; 428/343; 428/332; 428/354

(57) ABSTRACT

The present invention relates to a sticker for sticking onto an object, having an upper side (Ia) and an underside (Ib), having a substrate (2) which is provided on the upper side (Ia) and has a region (3) for storing an optical structure, having a contact surface (4, 11) which is provided on the underside (Ib), and having an adhesive (5, 6, 12, 14) which is connected to the contact surface (4, 11) for sticking the sticker (A1, A2, A3, A4, A5, A6) onto the object. The problem of specifying a sticker for sticking onto an object, which sticker ensures satisfactory quality of the reproduction of the information contained in the optical structure even in the case of unevennesses of the surface to be adhesively bonded, is solved by at least one part region of the substrate (2) being decoupled from the object in force terms in the adhesively bonded state.

The present invention relates to a sticker for adhering to an object, having a top face and a bottom face, having a substrate which is provided on the top face and has a region for the storage of an optical structure, having a contact surface provided on the bottom face, and having a bonding means which is connected to the contact surface and is intended for adhering the sticker to the object.

Stickers of this kind are used for identifying objects, such as packages, for example. In its simplest form, the sticker in this case can be two-dimensional and planar, so that it can be adhered to an object by its bottom face, forming the contact surface, in the manner of a label.

Provided for the purpose of the adhering of the sticker is a bonding means connected to the contact surface. The bonding means may be, for example, a pressure-sensitive adhesive (PSA) which is applied in the form of an adhesive composition or adhesive sheet to the contact surface. To adhere the sticker to the object, the sticker is pressed onto the object by its contact surface bearing the bonding means.

In stickers of this kind, on the top face of the sticker, which is opposite the bottom face, there is typically a substrate provided which has a region for the storage of an optical structure. In the simplest case the top face of the substrate may itself form the top face of the sticker, and the bottom face of the substrate may form the contact surface. In this case the bonding means is applied directly to the bottom face of the substrate. Alternatively the substrate can also be lined on its top and/or bottom face, by means, for example, of a protective film. Moreover, substrates of this kind generally have an absorber layer and/or a mirror layer.

In the substrate of the sticker it is possible to store information in the form of an optical structure. In the substrate it is possible to store information concerning, for example, the origin, nature and/or production of the object to be identified. The information in question may also be individualizing information for the purpose of securing the object against counterfeiting. The information can typically be both optically written and optically read. In this case the optical structure may be stored more particularly as a holographic optical structure in the substrate. There are diverse possibilities for this, preference being given to the generation of a computer-generated hologram by the writing of a dot matrix in the substrate. This can be done, for example, using a laser.

In the prior art the substrate is frequently composed of a polymer film and an absorber layer and/or a mirror layer. The substrate flexibility associated with the materials employed for the substrate harbors difficulties when the sticker is adhered to an uneven base. The reason for this is that, in that case, the substrate—and, together with it, the arrangement of the optical structure—likewise takes on an uneven form when it is adhered to the base, in conformation to the form of the base. Because the above-described optical structures are directionally dependent diffraction gratings, and rays diffracted by the grating are caused to interfere in order for the information to be read from the optical structure, the quality of reproduction of the information is very heavily dependent on the deformation of the structure itself.

Where the sticker is adhered, for example, to glass, unevennesses in the structure come about essentially only as a result of inhomogeneities in the material or in the bonding means used itself.

If, on the other hand, the sticker is bonded to a rough or flexible surface, as is often the case with surfaces of packages, made of cardboard, for example, then the sticker may at least partly take on a surface form which deviates from a plane, thereby giving rise to a nonplanar optical structure. A possible result of this is that the optical information can no longer be reliably read. Unevennesses with height differences in the region of just 200 nm are critical in this respect.

The technical problem addressed by the present invention is therefore that of specifying a sticker, intended for adhering to an object, that ensures good quality of reproduction of the information contained in the optical structure, even in the event of unevennesses in the surface to which bonding is to take place.

In accordance with the invention this problem is solved, for a sticker of the type specified at the outset, by, in the adhered state, at least a subregion of the substrate being force-decoupled from the object.

The basic concept of the invention lies in at least partly decoupling the sticker substrate from the object. Force-decoupled in this context means that, within the force-decoupled region, any unevennesses in the object cannot be transmitted to the sticker. Forces which might lead to a transmission of unevennesses in the object to the sticker are unable to act in the force-decoupled region, or within that region their action is insufficient to lead to any transfer of unevennesses to the sticker, and more particularly the substrate, that would adversely affect the legibility of the information. The force decoupling thus ensures that, even in the case of uneven objects, the legibility of the information stored in the substrate is reliably possible at any time. In this context, of course, the entire substrate, and more particularly the entire sticker, may be force-decoupled from the object.

Accordingly the force-decoupled region of the substrate, even after the sticker has been adhered to an object, is free to retain its original, typically substantially planar, form. Within this region there is no conformation of the sticker to any unevennesses in the base, in particular even small unevennesses, so that, even in the case of uneven bases, reliable reproduction of the information stored in the substrate is possible. More particularly there is in this case no adverse effect on the legibility as a result of deviations in the substrate, and hence of the optical structure stored therein, from a planar form.

The optical structure may more particularly be stored in the substrate even prior to the adhering of the sticker. It is also conceivable, though, not to store the optical structure in the substrate until after the sticker has been adhered. In its simplest form, the sticker may be of two-dimensional and substantially planar design. It is possible, for example, for the top face of the substrate itself to form the top face of the sticker. It is likewise conceivable for the bottom face of the substrate itself to form the contact surface.

In order to ensure optimum legibility of the information in the entire region for the storage of the optical structure in the substrate, it is possible, in accordance with one preferred embodiment, for provision to be made for at least the subregion of the substrate that carries the region for the storage of the optical structure to be force-decoupled from the object. In this case, therefore, the region for the storage of the optical structure is force-decoupled, with the consequence that throughout the region of the stored information there is no detrimental conformation to unevennesses in the object.

In accordance with one embodiment the force decoupling of the subregion of the substrate is achieved in a particularly simple way by, in the adhered state, only a subregion of the contact surface being connected by the bonding means directly to the object. The contact surface is therefore only partly bonded to the object. A “composition-free zone” is created in the region in which there is no direct connection to the object by bonding means. The region of the substrate that is assigned to this region is force-decoupled, and in this region, therefore, there can be no detrimental conformation of the sticker to unevennesses in the object.

In order to ensure that the connection of the sticker to the object is secure, and is not jeopardized even in the course of the use of the object, it is possible, in accordance with one preferred embodiment, for provision to be made that, in the adhered state, at least one marginal region of the contact surface is connected by the bonding means directly to the object. This embodiment ensures that the sticker is not accidentally detached, by the margin, from the object. In this case, more particularly, for a particularly secure connection, two opposite marginal regions, or else all of the marginal regions, of the contact surface may be connected by the bonding means directly to the object.

In order to ensure optimum legibility of the information for the complete region for the storage of the optical structure in the substrate, it is possible, in accordance with one particularly preferred embodiment, for provision to be made that, in the adhered state, the region of the contact surface that is opposite the region for the storage of the optical structure is not connected directly to the object. In the case of a planar sticker, therefore, the region of the contact surface that is situated below the region for the storage of the optical structure is not bonded directly to the object. Accordingly it is ensured, for the entire region for the storage of the optical structure, that there is no conformation to any unevennesses of the base. Legibility of the optical structure is therefore possible, in an even more reliable way, even after the act of adhering to a nonplanar base.

In order securely to ensure the readability of the whole optical structure at any time, the region of the contact surface that is opposite the region for the storage of the optical structure, and that in the adhered state is not connected directly to the object, can have the same size as the region for the storage of the optical structure. This ensures that the region for the storage of the optical structure cannot undergo deformation as a result of any unevennesses in the base and so cannot possibly adversely affect the legibility of an optical structure stored in the region.

In order to achieve even further-increased security when reading the optical structure, it may be advantageous, furthermore, if the region of the contact surface that is opposite the region for the storage of the optical structure and that in the adhered state is not connected directly to the object is larger than the region for the storage of the optical structure—in other words, more particularly, covers said region. In this case not only is the region of the contact surface that is opposite the region for the storage of the optical structure not bonded directly to the object, but also, furthermore, an additional region, more particularly an adjacent region, of the contact surface is not bonded directly to the object. This prevents the possibility that, owing to the spreading of any conformations—conformations that come about in the region of direct contact with the object—of the substrate to object unevennesses in adjacent substrate regions, an adverse effect on the legibility of the optical structure may be produced. For this purpose the additional, adjacent, unbonded region of the contact surface ought to be disposed more particularly between the directly bonded region of the contact surface and the region opposite the region for the storage of the optical structure.

In a way which is particularly simple in practice, the partial bonding of the contact surface can be realized if the bonding means covers only part of the contact surface. It is, though, also conceivable for the bonding means to cover the contact surface completely. This may be the case more particularly when the sticker, for example, is provided as early as during its production, over the full area, with a bonding means on its bottom face, and this sticker is subsequently to be converted in accordance with the invention.

In order to achieve partial bonding of the contact surface of the sticker to the base, it is possible, in a way which is particularly simple in practice, for part of the bonding means to be covered by a nonadhesive material. Lining of this kind leads, moreover, to a stiffening of the substrate, thereby further reducing the risk of transmissions of object unevennesses to the substrate. A liner material of this kind may be, for example, a film which is nonadhesive on at least one side and which is applied to the bonding means at the point(s) where no direct connection with the contact surface of the sticker to the object is desired. This embodiment is of interest more particularly when the contact surface is fully covered by bonding means.

It is also conceivable for the bonding means to have a topography such that in the adhered state only a subregion of the contact surface of the sticker is connected by the bonding means directly to the object. In accordance with this embodiment the bonding means connected to the contact surface, therefore, has elevations or depressions which result in direct contact between the contact surface of the sticker and the object being developed only in particular regions when the sticker is adhered. Accordingly it is only in these regions that a direct connection by the bonding means comes about. The topography can be generated, for example, by applying the bonding means by a printing process (e.g., flexographic printing).

For the substrate a thickness of at least 25 μm has proven suitable, preferably in the range from 25 μm to 180 μm. In this case it is possible in principle, for the substrate and/or for the sticker, for a stiffness to be achieved which results in a reduction in conformation of the substrate to unevennesses of the base.

More particularly in the event that the force decoupling of the substrate is achieved by only a subregion of the contact surface being bonded by the bonding means directly to the object, a thickness of the substrate in the range from 25 μm to 75 μm has proven particularly suitable. In this case sufficient force decoupling is achieved simply by the only partial bonding of the sticker, with the consequence that a substrate thickness of 25 μm to 75 μm is sufficient as a measure possibly supporting the force decoupling.

In accordance with one further embodiment the force decoupling of at least one subregion of the substrate is achieved by the substrate having a thickness of greater than 50 μm, preferably in the range from 75 μm to 180 μm. In that case, the actual increased stiffness associated with the increased thickness of the substrate is enough to achieve a force decoupling which prevents the sticker conforming to object unevennesses. It has been recognized, therefore, that, above a given sticker thickness, it is possible for the flexibility of the sticker to be reduced to such an extent that unevennesses are largely compensated and the proper reproduction of the information—holographic information, for example—is ensured. More particularly, increased substrate stiffness also reduces the spread of any substrate unevennesses into adjacent substrate regions. An additional force decoupling by means of only partial bonding of the contact surface is no longer necessary in this case. Of course, however, a combination of both measures in order to optimize the force decoupling is possible.

In accordance with one alternative or additional embodiment the force decoupling is achieved by the assembly formed from the substrate and the bonding means having a thickness of greater than 75 μm. In this case as well, the thickness of the assembly reduces the flexibility of the sticker in such a way that force decoupling sufficient to prevent detrimental conformation to object unevennesses is ensured. Again, in this case, an additional force decoupling through only partial bonding of the contact surface is unnecessary. In spite of this, however, it is of course an additional possibility in order to optimize the force decoupling.

In accordance with a further teaching the substrate may have a multilayer construction. Through a suitable choice of the layers it is possible to raise the stiffness of the substrate further, so that a desired force decoupling can be achieved in this way as well. Further layers of suitable materials may be added, more particularly, that serve merely to increase the stiffness. In principle, however, it is also conceivable to provide additional layers for the purpose of storing further information. The various layers of the substrate may be connected to one another more particularly by a bonding means.

In the case of a multilayer construction the substrate may more particularly have a carrier layer having a thickness of at least 25 μm, preferably in the range of 25 μm to 180 μm, and an additional carrier having a thickness of greater than 25 μm, more particularly in the range from 50 μm to 180 μm. A multilayer construction of this kind allows the sticker to attain a stiffness which reduces conformation to unevennesses in the base as a result of a force decoupling. The carrier layer may in this case be designed more particularly in the form of a carrier film. The carrier layer may be made of material suitable for the writing of optical structures, while the additional carrier may have suitable elasticity properties to allow sufficient stiffness of the sticker to be ensured. In this way the multilayer construction leads to a further reduction in conformations to object unevennesses.

In the case of such a multilayer construction, the carrier layer may have a thickness of at least 25 μm, preferably in the range from 25 μm to 75 μm, with further preference in the range from 36 μm to 75 μm. Such thickness values for the carrier layer have proven suitable more particularly when force decoupling is achieved through only partial bonding of the contact surface to the object.

In the case of the multilayer construction the carrier layer may also have a thickness of greater than 50 μm, preferably in the range from 75 μm to 180 μm. A construction of this kind, and more particularly the combination of the specified layer thickness of the carrier layer, of greater than 50 μm, preferably in the range from 75 μm to 180 μm, and that of the additional carrier, of greater than 25 μm, more particularly in the range from 50 μm to 180 μm, lead to stiffness values and hence to a force decoupling of the substrate that ensure that the substrate and, therefore, the optical structure stored within it continue to retain their typically planar form, substantially, even after adhesion to an uneven object. The force decoupling achieved in this way is sufficient to ensure securely the reading of the stored information even in the case of nonplanar bases. Additional measures, such as an only partial bonding of the sticker to the object, are not necessary here. Such measures can of course be employed additionally, however, in order to optimize the force decoupling.

In a further-preferred way the thickness of the bonding means is chosen to be more than 25 μm, the thickness being situated more particularly in the range of 30-90 μm. In this way it is also possible to adjust the stiffness of the sticker by adjusting the thickness of the adhesive.

Furthermore, the bonding means may be adjusted in its hardness and/or in its rheology in such a way that the bonding means is able to compensate the distance fluctuations between a rough base and the planar sticker without instances of detachment.

The substrate preferably has a polymer film, more particularly a biaxially oriented polymer film. Films of this kind can be produced effectively and are easy to adhere to an object. Moreover, it is known to be particularly easy to write information, in the form for example of a computer-generated hologram, into biaxially oriented polymer films by locally cancelling out the orientation of the polymer film by means of local introduction of energy—by a laser beam, for example—and hence producing an optically readable local change in the film.

Preferably, moreover, and in conventional manner, the substrate additionally has an absorber layer and/or a mirror layer, such as an aluminum layer, for example.

Suitable material for the substrate, more particularly for the carrier layer in the case of the multilayer construction, includes, for example, polyethylene terephthalate (PET), polypropylene (PP) or other materials.

The optical structure may be designed more particularly as a diffracting structure. With structures of this kind it is possible to store a large quantity of information in a small space. It is preferred here for the optical structure to be designed as a holographic structure, more particularly as a computer-generated hologram. Besides a large storage capacity for information, computer-generated holograms can be written and read quickly by means, for example, of lasers.

In a particularly simple way it is possible for the written information to be matched individually to the object that is to be identified using the sticker.

In order to analyze the stiffness of materials of the kind described above, a determination was made of the tensile impact strength of various materials in accordance with DIN 53448. The measurements obtained were as follows:

A standard PET film with a thickness of 50 μm had a tensile impact strength of greater than 1885 KJ/m².

In the case of a PET film used in accordance with one of the above-described embodiments of the present invention, with a thickness of 75 μm, a tensile impact strength of greater than 2400 KJ/m² was measured.

In the case of a combination of a standard PET film 50 μm thick and a bonding means with a thickness of 25 μm a tensile impact strength of greater than 2965 KJ/m² was measured. The other materials measured, PET films with a thickness of 96 μm, 125 μm, and 180 μm, and also a material consisting of a PET film, with a thickness of 50 μm, a bonding means, 25 μm thick, and an additional carrier in each case had a tensile impact strength of more than 5200 KJ/m². The materials used consequently have a stiffness appropriate for achieving the above-described effect of improving the read information from the optical structures by means of force decoupling.

The invention is elucidated in more detail below with reference to further exemplary embodiments. Diagrammatically and in a cross section,

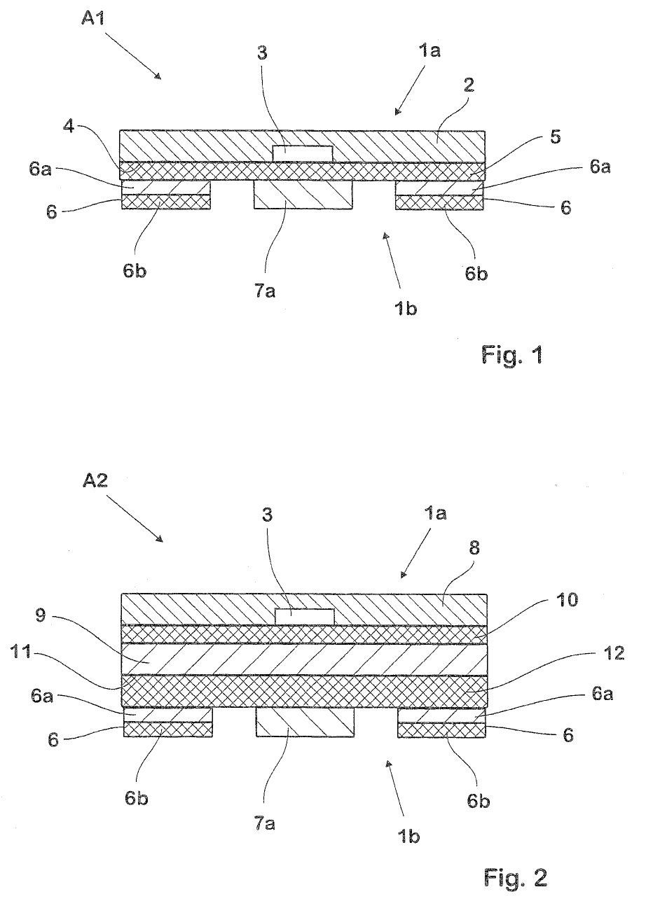

FIG. 1 shows an inventive sticker in one first embodiment,

FIG. 2 shows an inventive sticker in one second embodiment,

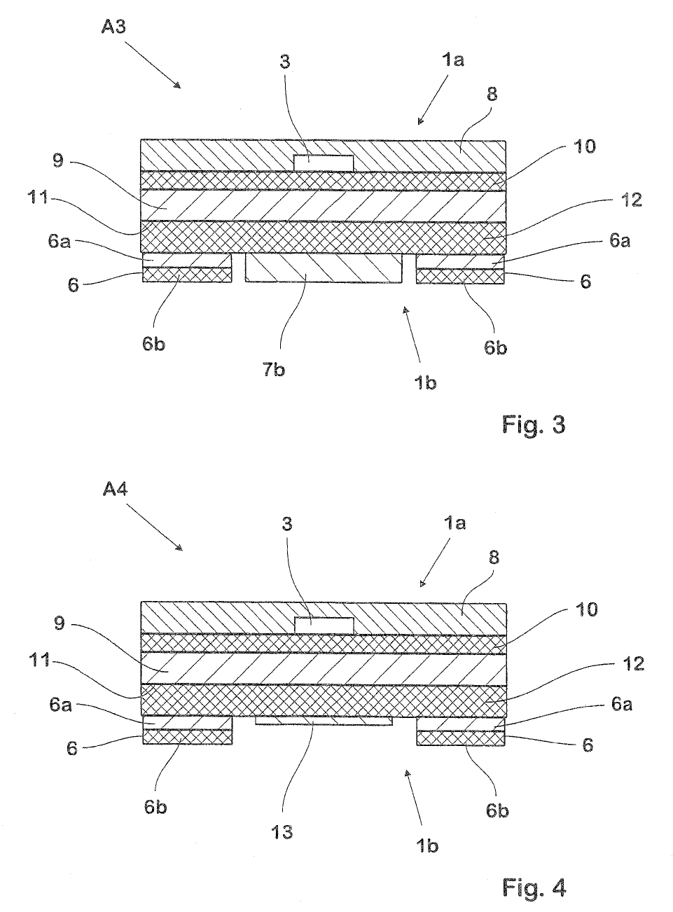

FIG. 3 shows an inventive sticker in one third embodiment,

FIG. 4 shows an inventive sticker in one fourth embodiment,

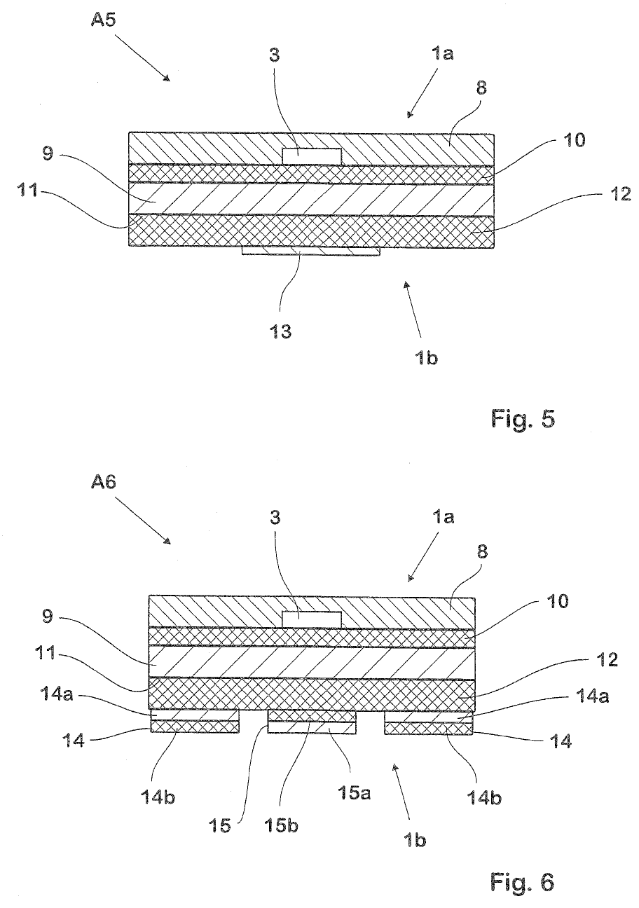

FIG. 5 shows an inventive sticker in one fifth embodiment, and

FIG. 6 shows an inventive sticker in one sixth embodiment.

FIG. 1 shows a sticker A1 having a top face 1a and a bottom face 1b. The sticker A1 has a substrate 2 which carries a carrier layer and has a region 3 provided on the bottom face of the substrate 2 and intended for the storage of an optical structure, more particularly of a computer-generated hologram. In conventional manner, moreover, the substrate 2 has an absorber layer and/or mirror layer, which are not shown further.

The carrier layer of the substrate 2 is composed in the present example of a biaxially oriented polymer film, more particularly of polyethylene terephthalate (PET). The substrate 2 possesses a planar form and in plan view is substantially square. In the example shown in FIG. 1 the substrate 2 possesses a square area of 20 mm² and a thickness of 50 μm. The surface of the substrate 2 itself forms the top face 1a of the sticker A1.

The region 3 for the storage of the optical structure extends perpendicularly to the plane of the drawing in FIG. 1, in the form of a stripe and centrally, over the entire length of the substrate. For the storage of the optical structure, the region 3 is smaller in width than the substrate 2, possessing more particularly a width of approximately 2 mm to 5 mm. Different dimensions of the region 3 for the storage of the optical structure are of course possible.

In the example shown in FIG. 1, the substrate 2 forms with its bottom face itself a contact surface 4 for the application of an object, which is not shown. The object may be, for example, a packaging material, made of card, for example, more particularly for cigarette packs.

Beneath the substrate 2 there is a layer of a bonding means 5, in the present example a pressure-sensitive adhesive composition (PSA), which covers the entire bottom face of the substrate 2. In the exemplary embodiment shown this layer possesses a thickness of 25 μm.

Provided a long two opposite margins of the bonding means layer 5 is in each case a bonding means strip 6. The bonding means strips 6 have a nonadhesive side 6a and an adhesive side 6b. Suitable materials for the bonding means strips are adhesive sheets, of the kind obtainable, for example, under the name “tesa-film”. The bonding means strips 6 are each applied by their nonadhesive side 6a to the bonding means layer 5 and in that way are connected to it. The adhesive side 6b of the bonding means strips 6 points downward away from the sticker A1. In the example shown, the bonding means strips 6 have a width of 5.0 mm and a thickness of 58 μm, and extend perpendicularly to the plane of the drawing, i.e., in parallel to the region 3 for the storage of the optical structure, over the entire length of the substrate 2.

Extending centrally between the bonding means strips 6 and in parallel therewith is a cover strip 7a which is of nonadhesive design and which is connected by one side to the bonding means layer 5. In the example it has a width of 6.0 mm and a thickness of 55 μm and, like the strips 6, extends over the entire length of the substrate 2. The cover strip 7a therefore extends beneath the region 3 for the storage of the optical structure and in parallel with said region. In the present example the cover strip 7a is composed of polypropylene (PP). Between the cover strip 7a and the bonding means strips 6 there is a gap of in each case 2.0 mm.

To adhere the sticker A1, it is pressed by its bottom face 1b onto the object. As a result of the bonding means layer 5 and the bonding means strips 6, the bonding means applied to the contact surface 4 of the substrate 2 has a topography which means that, when the sticker A1 is adhered, only a subregion of the contact surface 4 is connected directly by bonding means to the object, namely the region in which the bonding means strips 6 are disposed. In this case, in the manner of a spacer, the cover strip 7a prevents unwanted contact between the bonding means layer 5 and the object in the middle region as well, as a result of the pressing of the flexible sticker A1 onto the object, and therefore prevents a direct bonding of this region.

The sticker A1 adhered to the object is therefore connected directly to the object only along the bonding means strips 6. The region situated between them of the contact surface 4 and hence of the substrate 2 is force-decoupled from the object and is therefore free to retain its original planar form even after being adhered to a nonplanar object. Accordingly, any conformation of the substrate to unevennesses that adversely affects the legibility of the optical structure does not occur in this region.

The width of the region 3 for the storage of the optical structure is designed in this case such that, in the adhered state, the region of the contact surface 4 that is opposite the region 3 for the storage of the optical structure is not connected by bonding means directly to the object, and, therefore, the region of the substrate 2 that carries the region 3 for the storage of the optical structure is force-decoupled from the object. Reliable readability is therefore ensured for the entire region 3 for the storage of the optical structure. Furthermore, the region that is not connected directly by bonding means to the object is broader than the opposite region 3 for the storage of the optical structure. This ensures that any spreading of unevennesses in the substrate 2 over the region extending beyond the region connected by the bonding means strips 6 directly to the object, in the direction of the region 3 for the storage of the optical structure, has no adverse effect on the legibility of the optical structure.

Even when the sticker A1 is adhered to a nonplanar base, therefore, it is ensured that the substrate 2 in the region of the contact surface 4 that is not connected directly to the object, and more particularly the region 3 for the storage of the optical structure, are free to retain a planar form. Conformation to unevennesses of the base takes place, if at all, only in the marginal regions of the substrate 2 that are connected by the bonding means strips 6 directly to the object.

Since, however, the region 3 for the storage of the optical structure is unaffected by this, reliable reproduction of the stored optical structure is securely ensured.

As a result of the cover strip 7a, moreover, the substrate enjoys increased stiffness. This prevents the transmission of conformations to unevennesses, taking place possibly in the region of the bonding means strips 6, to the region of the substrate that carries the region 3 for the storage of the optical structure.

FIG. 2 shows a second sticker A2. In this figure, reference symbols the same as those in FIG. 1 denote items that are the same. The sticker A2 differs from the sticker A1 shown in FIG. 1 merely in that the substrate has a multilayer construction. Hence the substrate according to FIG. 2 possesses a carrier layer 8, in the form of a film, which again has the region 3, designed in accordance with the embodiment of FIG. 1, for the storage of the optical structure.

The carrier layer 8 is planar and in plan view possesses an area of 20 mm². Beneath the carrier layer 8 there is a likewise planar additional carrier 9 of the same area that is fully connected to the carrier layer 8 by a bonding means layer 10. The substrate in the case of the sticker A2 shown in FIG. 2 therefore has the carrier layer 8 and the additional carrier 9 attached to the carrier layer 8 by the bonding means layer 10. Moreover, in conventional manner, again, the substrate has an absorber layer and/or mirror layer, which are not shown. In the example shown in FIG. 2 the carrier layer 8 possesses a thickness of 50 μm, the bonding means layer 10 a thickness of 25 μm, and the additional carrier 9 a thickness of 75 μm.

The carrier layer 8 is composed again of a biaxially oriented polymer film, more particularly of polyethylene terephthalate (PET). The additional carrier 9 in the present example is likewise composed of PET.

Whereas the carrier layer 8 according to FIG. 2 forms the top face of the sticker A2, the additional carrier 9 forms, with its bottom face, a contact surface 11 for the application of an object, which is not shown. Disposed beneath the additional carrier 9 is a layer of a bonding means 12 that covers the entire bottom face of the additional carrier 9, said bonding means being again, for example, a pressure-sensitive adhesive composition (PSA). In the example the bonding means layer 12 has a thickness of 25 μm.

Located beneath the bonding means layer 12, again, are the bonding means strips 6 and also the cover strip 7a, which produce the topography of the bonding means and have already been elucidated with respect to FIG. 1. They are no different in their embodiment and, more particularly, in terms of their dimensions than those according to FIG. 1. Once again, in the way described with respect to the sticker A1, the sticker A2 is adhered to the object. This produces the advantages already elucidated with respect to FIG. 1.

It has emerged, moreover, that the sticker A2 shown in FIG. 2, on account of its multilayer construction and the associated greater thickness as compared with the sticker A1 shown in FIG. 1, possesses an increased stiffness. This stiffness leads to a further improvement in the readability of the optical structure, owing to the even lower level of conformation of the substrate to unevennesses in the object.

Described hereinafter are further embodiments of inventive stickers. In all of the figures, reference symbols that are the same denote items that are the same. The embodiments are elucidated in each case for a multilayer substrate composed of carrier layer 8, additional carrier 9 connected to it by bonding means 10, and with bonding means layer 12 provided on the bottom face, as shown in principle in FIG. 2. By virtue of the multilayer construction, a substrate of this kind advantageously has an increased stiffness. Attention is drawn, however, to the fact that each of the embodiments described hereinafter can also be used in the case of a simple substrate 2, having only a carrier layer, and on whose bottom face there is a bonding means layer 5, such a substrate being shown in principle in FIG. 1.

Again, the substrates elucidated hereinafter have, in a manner known per se, an absorber layer and/or mirror layer, which are not shown in any greater detail.

The sticker A3 shown in FIG. 3 corresponds substantially to the sticker A2 shown in FIG. 2. In this case the sticker A3 differs from the sticker A2 only in terms of the width of the cover strip 7b and hence also in the distances between the cover strip 7b and the bonding means strips 6. In the example shown in FIG. 3 the cover strip 7b has a width of 9.0 mm. This reduces the distances to the bonding means strips 6 to 0.5 mm in each case. The dimensions of the remaining components shown in FIG. 3 match the dimensions of the corresponding components in FIG. 2.

The functioning and the advantages of the sticker A3 correspond substantially to the functioning and the advantages of the sticker A2.

The reduction in the distances between the cover strip 7b and the bonding means strips 6 in accordance with FIG. 3 further reduces the risk of contact and hence of unwanted sticking between the bonding means layer 12 and the object when the sticker A3 is pressed onto the object. Moreover, as a result of a widening of the cover strip 7b, the stiffness of the substrate is increased further, with the consequence that it conforms even less to any unevennesses in the object. Effectively prevented, more particularly, is the spreading of unevennesses that may be transmitted to the substrate in the region of the bonding means strips 6 to the middle part of the substrate that carries the region 3 for the storage of the optical structure.

Of course, the embodiment according to FIG. 3 can also be employed for a simple substrate 2 provided with a bonding means layer 5, of the kind shown in principle in FIG. 1.

FIG. 4 shows a further embodiment of an inventive sticker A4. The sticker A4 differs from the sticker A2 shown in FIG. 2 only in that, instead of the cover strip 7a, a thin cover strip 13 is provided. In the present example the cover strip 13 is composed of polypropylene (PP) and again extends centrally between the bonding means strips 6 and in parallel with them.

In the example according to FIG. 4 the strip 13 has a width of 8.0 mm and a thickness of 12 μm and, like the bonding means strips 6, extends over the entire length of the substrate. Between the cover strip 13 and the bonding means strips 6, therefore, there is in each case a gap of 1.0 mm. As far as the embodiment of the other components shown in FIG. 4 is concerned, there is no change from the embodiment of the corresponding components in, for example, FIG. 2.

It has emerged that satisfactory results can be achieved even with the cover strip 13 of FIG. 4, which is thin as compared with the embodiments of FIGS. 2 and 3. Thus even the cover strip 13 securely prevents sticking of the sticker A4 to the object in the regions outside the bonding means strips 6.

In this embodiment, more particularly, the planar form of the substrate is maintained to particularly good effect, thereby producing particularly good readability of the optical information. The multilayer construction of the substrate and the associated increased stiffness mean that even without the presence of a spacer there is no lowering of the middle substrate region onto the object.

Of course, again, the embodiment according to FIG. 4 can also be employed for a simple substrate 2 provided with a bonding means layer 5, of the kind shown in principle in FIG. 1.

FIG. 5 shows a sticker A5 in accordance with one further embodiment. The sticker A5 shown in FIG. 5 differs from the sticker A4 of FIG. 4 in that the bonding means strips 6 have not been provided. Instead the bonding means layer 12, provided over the full area of the contact surface 11 of the substrate, is covered only by the cover strip 13 already provided in the case of the sticker A4 of FIG. 4. As for FIG. 4 already, the cover strip has a width of 8.0 mm and a thickness of 12 μm. The embodiment of the other components shown in FIG. 5 matches the embodiment of the corresponding components in FIG. 4.

When the sticker A5 is adhered to an object, there is a slight heightening of the substrate and hence of the optical structure, along the cover strip 13, since the adjacent regions of the bonding means layer 12 are lowered in the course of pressure application to the object. It has emerged, however, that this does not adversely affect the readability of the optical structure. More particularly, the lowered region of the substrate lies outside the region 3 for the storage of the optical structure. Furthermore, the degree of the lowering in the case of the thin cover strip 13 provided in accordance with FIG. 5 is small in any case, and so the optical structure itself can be read even when the optical structure is affected by the lowering.

Once again, the embodiment of FIG. 5 can of course likewise be employed for a simple substrate 2 provided with a bonding means layer 5, of the kind shown in principle in FIG. 1.

In principle it is of course also conceivable for the bonding means layer 5 or 12 to only partly cover the substrate in each case, so that in this way there is only partial direct bonding of the contact surface 4 or 11 to the object. More particularly, the embodiments according to FIGS. 4 and 5, as a result of the thin cover strip 13, achieve a comparable effect.

FIG. 6 shows a sticker A6 in accordance with one further embodiment. The sticker A6 has a substrate with a multilayer construction, of the kind shown in principle, for example, in FIG. 2. In contradistinction to the embodiment of FIG. 2, however, the substrate, or its individual layers, has a square area of only approximately 12 mm². The thicknesses of the individual layers of the substrate and also of the bonding means layer 12 again match those of FIG. 2. Also matching the embodiment of FIG. 2 is the embodiment of the region 3 for the storage of the optical structure.

In the case of the sticker A6 of FIG. 6 there are three bonding means strips 14, 15 which extend in parallel with one another on the bottom face of the bonding means layer 12 and which each extend, perpendicularly to the plane of the drawing, over the entire length of the substrate. The strips may be composed, for example, of an adhesive sheet obtainable under the name “tesa-film”. In this case two bonding means strips 14 each extend along two opposite margins of the substrate, and the third bonding means strip 15 extends centrally between the two other strips 14. The strips 14, 15 each have a nonadhesive face 14a, 15a and an adhesive face 14b, 15b. In the example shown, the bonding means strips 14, 15 each possess a thickness of approximately 38 μm.

Whereas the two strips 14 extending along the margins of the substrate have a width of 3.5 mm, the centrally disposed third strip 15 possesses a width of 3 mm in the example shown. Between the centrally disposed strip 15 and the two strips 14 provided on the margins of the substrate, therefore, there is in each case a gap of 1.0 mm.

The two strips 14 extending along the margins of the substrate are each applied by their nonadhesive face 14a to the bonding means layer 12, while their adhesive face 14b points away in each case from the bottom face 1b of the sticker A6. The bonding means strip 15 extending centrally between the strips 14 that extend at the margin, in contrast, is applied by its adhesive face 15b to the bonding means layer 12, while its nonadhesive face 15a points away from the bottom face of the sticker A6.

In the same way as for the stickers according to FIGS. 1 to 5, the sticker A6 shown in FIG. 6 is pressed by its bottom face 1b onto the object, which is not shown. In this case, again, there is direct bonding of the contact surface 11 to the object only in the region of the two bonding means strips 14 which extend at the margin of the substrate.

In the region of the central bonding means strip 15, in contrast, there is no direct connection to the object through bonding means. As already in the case of FIGS. 1 to 3, the central bonding means strip 15 acts substantially as a spacer relative to the object.

In this case it has emerged that, through the use of the same material for the centrally provided bonding means strip 15, acting as a spacer, and the strips 14 provided laterally at the margins, it has been possible to achieve increased flatness of the substrate even following its adhesion to a nonplanar base. The reduction in the substrate surface area likewise did not lead to any problems with regard to the legibility of the optical structure. Through the use of only one kind of strip material, moreover, the production of the sticker is simplified further.

The embodiment of FIG. 6 as well, and more particularly the smaller area of the substrate, can of course likewise be employed for a simple substrate 2 provided with a bonding means layer 5, of the kind shown in principle in FIG. 1.

It is noted that the dimensions of the components of the inventive stickers, as indicated in the exemplary embodiments, are given merely by way of example. Different dimensions are of course possible. More particularly it is possible to use thicker layers for the individual layers of the sticker, or else for subregions of the layers of the sticker, and in that way, by means of an increased stiffness, to achieve force decoupling of the entire substrate, or of subregions of the substrate, from the object. An additional, only partial, bonding of the sticker is no longer mandatory in such a case for the purpose of force decoupling. The sticker can therefore be bonded over its whole area to the object, with the requisite force decoupling being ensurable solely by virtue of the stiffness of the sticker.

Similarly, any materials specified are given purely by way of example. Other materials can also be employed.

In accordance with all of the embodiments of the invention it is reliably ensured that there is no unevenness in the substrate, adversely affecting the legibility of the optical structure, as a result of unevennesses in the object.

1-22. (canceled)

23. A sticker for adhering to an object, the sticker comprising
a top face (1a) and a bottom face (1b),
a substrate (2) provided on the top face (1a), the substrate having a region (3) for accommodating an optical structure,
a contact surface (4, 11) disposed on the bottom face (1b),
a bonding means (5, 6, 12, 14) being connected to the contact surface (4, 11) for adhering the sticker (A, A2, A3, A4, A5, A6) to the object, and
wherein the substrate (2) is partially force-decoupled in a subregion from the object.

24. The sticker of claims 23, wherein in only a subregion of the contact surface (4, 11) is connected by the bonding means (5, 6, 12, 14) directly to the object.

25. The sticker of claim 24, wherein at least one marginal region of the contact surface (4, 11) is connected by the bonding means (5, 6, 12, 14) directly to the object.

26. The sticker of claim 24, wherein the region (3) for accommodating an optical structure in the contact surface (4, 11) is not connected directly to the object.

27. The sticker of claim 26, wherein the contact surface (4, 11) opposite the region (3) for the storage of the optical structure is not connected directly to the object has the same size as the region (3) for the storage of the optical structure.

28. The sticker of claim 26, wherein the contact surface (4, 11) opposite the region (3) for the storage of the optical structure connected directly to the object is larger than the region (3) for the storage of the optical structure.

29. The sticker of claim 24, wherein the bonding means (5, 6, 12, 14) covers the contact surface (4, 11) only partially.

30. The sticker of claim 24, wherein the bonding means (5, 6, 12, 14) covers the contact surface (4, 11) completely.

31. The sticker of claim 24, wherein the bonding means (5, 6, 12, 14) is partially covered by a nonadhesive material (7a, 7b, 13, 15).

32. The sticker of claim 23, wherein the bonding means (5, 6, 12, 14) only a subregion of the contact surface (4, 11) of the sticker (A1, A2, A3, A4, A5, A6) is connected by the bonding means (5, 6, 12, 14) to the object.

33. The sticker of claim 23, wherein the substrate (2) has a thickness of at least 25 μm, preferably in the range from 25 μm to 180 μm.

34. The sticker of claim 33, wherein the substrate (2) has a thickness in the range from 25 μm to 75 μM.

35. The sticker of claim 23, wherein the substrate (2) has a thickness of greater than 50 μm.

36. The sticker of claim 23, wherein the substrate (2) and the bonding means (5, 6, 12, 14) has a thickness of greater than 75 μm.

37. The sticker of claim 23, wherein the substrate (2) has a multilayer construction.

38. The sticker of claim 37, wherein the substrate (2) includes a carrier layer (8) having a thickness of at least 25 μm and has an additional carrier (9) having a thickness of greater than 25 μm.

39. The sticker of claim 38, wherein the carrier layer (8) has a thickness of at least 25 μm.

40. The sticker of claim 38, wherein the carrier layer (8) has a thickness of greater than 50 μm.

41. The sticker of claim 23, wherein the substrate (2) includes a polymer film.

42. The sticker of claim 23, wherein the optical structure is designed as a diffracting structure.

43. The sticker of claim 42, wherein the optical structure is designed as a holographic structure, more particularly as a computer-generated hologram.

44. The sticker of claim 23, wherein the substrate (2) has a thickness of about 75 μm to 180 μm.

45. The sticker of claim 39, wherein the carrier layer (8) has a thickness of about 25 μm to 180 μm, and has an additional carrier (9) having a thickness of greater than 25 μm, preferably in the range from 50 μm to 180 μm.

46. The sticker of claim 45, wherein the additional carrier (9) has a thickness of about 50 μm to 180 μm.

47. The sticker of claim 38, wherein the carrier layer (8) has a thickness of about 25 μm to 75 μm.

48. The sticker of claim 38, wherein the carrier layer (8) has a thickness of about 75 μm to 180 μm.

49. The sticker of claim 41, wherein the polymer film is a biaxially oriented polymer film.
